(19) United States
(12) Patent Application Publication
(10) Pub. No.: US 2010/0199162 A1
(43) Pub. Date: Aug. 5, 2010

(54) Form Management System

(76) Inventor: John Boucard, Pasadena, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/365,036

(22) Filed: Feb. 3, 2009

(51) Int. Cl. G06F 17/21; G06F 3/041; H04L 9/32

(52) U.S. Cl. 715/224; 345/173; 726/5

(57) ABSTRACT

A form management system includes a handheld reading device that receives data from a user who fills out a form attached to the handheld reading device. The handheld reading device stores the data on a removable personal storage device. The handheld reading device uses unique user identifiers to control access to the personal storage device. A user is authenticated before the user input can be received and stored. Data stored in the personal storage device can be uploaded to a management server for remote access by authorized personnel.

### FIELD OF THE INVENTION

The embodiments of the present invention relate to form management using electronic devices. Specifically, the embodiments of the invention relate to the management of forms and personal data using a portable personal storage device.

### BACKGROUND OF THE INVENTION

Many organizations use standardized or customized forms to solicit and collect information. For example, a patient who checks into a hospital or visits a doctor's office is usually confronted with the task of filling out a number of medical or insurance forms. These forms generally request identifying information of the patient (such as name, address, phone number, birth date, account number, etc), and collect additional information from the patient (such as the purpose of the visit, the symptoms, etc). Financial institutions, such as banks and brokerage firms, also routinely request their customers to fill out forms before a transaction can take place. However, a person may sometimes not have all the requested information to fill out the forms. For example, a person may not remember his account number or member ID. Further, filling out the personal identifying information can be cumbersome especially when the person is asked to fill out multiple forms during the same visit.

Another issue with the conventional forms is the inefficiency in data entry. Typically, the data filled out on the form is manually entered into a computer system by a clerk. Thus, a clerk has to collect the forms, locate the account, and type in the data in the form. Manual data entry is time consuming and error prone.

### SUMMARY

The embodiments of the invention include a form management system that uses a handheld reading device to collect personal data and a removable personal storage device to store the collected personal data. The handheld reading device receives data from a user who fills out a form attached to the handheld reading device. The form can be filled out by the user with a finger touch or any writing utensil, such as a graphite pencil. The handheld reading device receives the user input through a touchpad or embedded components in a paper form printed with conductive ink.

The handheld reading device stores the input data on the personal storage device. Access to the personal storage device is controlled using unique user identifiers. The unique user identifiers include one or more of a password, a user ID, and biometric data such as a fingerprint. A user is authenticated before the input data can be received and stored. Data stored in the personal storage device can be uploaded to a management server for remote access by authorized personnel.

### BRIEF DESCRIPTION OF THE DRAWINGS

Embodiments are illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

FIG. 1 is a diagram of one embodiment of a form management system.

FIG. 2A is a diagram of one embodiment of a personal storage device that can be removably coupled to the form management system of FIG. 1.

FIG. 2B is a diagram of one embodiment of a personal storage device attached to a bracelet.

FIG. 3 is a block diagram of a networked system for managing data captured by the form management system of FIG. 1.

FIG. 4 is a flow diagram of one embodiment of a process for capturing data from the form management system of FIG. 1.

FIG. 5 a diagram of one embodiment of a form management device with an attached personal storage device.

### DETAILED DESCRIPTION

A method and system for a form management system is described. In one embodiment, the form management system includes a handheld reading device that receives data input from a user and stores the data on a personal storage device. The personal storage device is coupled to the handheld reading device during data input and can be removed from the handheld reading device after the data input is finished. The data stored in the personal storage device can be uploaded to a management server for remote access by authorized personnel.

The personal storage device can be carried around by its user to store personal information, such as medical data, financial data, or other sensitive personal data. One or more user identifiers are used to control access to the personal storage device. The user identifiers include one or more of a password, a user ID, and biometric data such as a fingerprint. The form management system authenticates the user before the user input can be received and stored. User input can be entered by filling out a form with a touchpad or a writing utensil, such as a graphite pencil. The form may be a paper form printed with conductive ink. The conductive ink embeds circuit elements and switches into the form. A user can select a field on the form by activating a switch embedded in the location of the field.

The examples and embodiments described herein below are related to the management of medical data that is collected from a form. However, one skilled in the art would understand that the components, techniques and principles described herein with regard to medical form data is applicable to the management of similar types of data and systems including financial data, membership data, government data and similar data sources. For the sake of clarity, the embodiments and examples are given in relation to the medical form data; however, one skilled in the art would understand that the other types of data can also be managed using the same methods and structures.

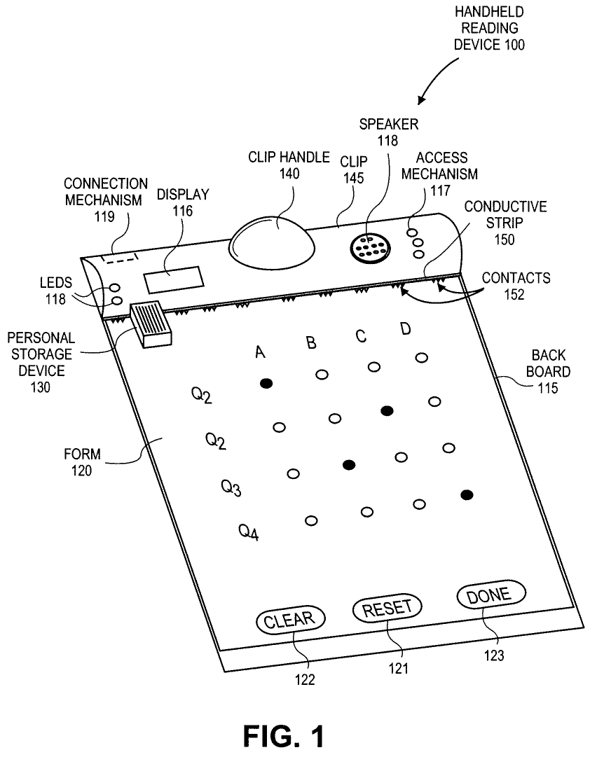

FIG. 1 is a diagram of one embodiment of a form management system that includes a handheld reading device 100. The handheld reading device 100 has a housing that includes a backboard 115 on which a form 120 can be placed. The form 120 can be a medical form, an investor form, or any form that solicits personal information. The form 120 can be securely attached to the handheld reading device 100 by a clip 145 on the top portion of the backboard 115. The clip 145 has a handle 140 on top, which can be held down by a user to open the clip 145 and to remove the form 120 from the clip 145. On the bottom portion of the clip 145 that faces the form 120 is a conductive strip 150. The conductive strip 150 includes multiple conductive contacts 152 to form electrical contacts with embedded circuits on the form 120. The conductive strip 150 and the conductive contacts 152 may or may not be visible when the clip 145 is closed. A personal storage device 130 is removably coupled to the handheld reading device 100 to store data collected from the form 120. A personal storage device 130 also stores one or more unique identifiers of a user, including a password, a user ID and biometric data, such as fingerprint, retinal pattern, heart beat, or other biometrics that can uniquely identify a user. In the embodiment of FIG. 1, the personal storage device 130 is inserted into an I/O port on the clip 145. However, it is understood that the personal storage device 130 may be placed on a different part of the handheld reading device 100 and may have a different form factor from the one shown in the figure.

The handheld reading device 100 also includes an access control mechanism 117, such as buttons, switches, a keyboard, a keypad, a sensor, a scanner, etc. The access mechanism 117 can be provided for receiving identifying data from a user to control data access to the personal storage device 130. In one embodiment, the access control mechanism 117 also includes a biometric sensor, such as a scanner, to measure or sense a user's biometric data. The access control mechanism 117 forwards the received identifying data to a processing element in the handheld reading device 100 for comparison with stored identifiers in the personal storage device 130. A person will be denied access to data in the personal storage device 130 if there is a mismatch in the comparison.

The handheld reading device 100 includes a display 116 (e.g., a liquid crystal display (LCD)), one or more light emitting diodes (LEDs) 118, and other type of display, to display the status of data entry and to provide feedback to the data entry. The handheld reading device 100 also includes a speaker 118, such as an electro-acoustic transducer, to produce sounds. The sounds can be used to announce the status of data entry and to provide feedback to the data entry. The handheld reading device 100 also includes a connection mechanism 119 for connecting to an external computing device and transporting the user's input to the computing device. The connection mechanism 119 can utilize physical connections (e.g., a cable connecting to a universal serial bus (USB) port or an internal USB port), wireless connections (e.g., an infra-red (IR) or a radio frequency (RF) I/O port), or other types of connections.

In one embodiment, the form 120 is a piece of paper that includes embedded components printed with conductive ink and/or resistive ink. Each form may be identified by a unique form ID. The form 120 contains one or more questions (e.g., Q₁-Q₄), such as true/false questions, multiple choice questions, or other types of questions that can be answered by selecting from given fields (e.g., A-D). The form 120 may additionally contain one or more printed buttons, such as a reset button 121 to restart a data entry process, a clear button 122 to clear an answer and a done button 123 to signify the end of a data entry process. Embedded within each selectable item (e.g., a field or a button) is a switch, which can be activated (closed) by touching or pressing the location where the item is printed. A user can touch or press the location of the form 120 where an item is printed with his finger, stylus, pencil, or any similar type of object. The contact activates the switch embedded in the location of the selected item to generate an output to the handheld reading device 100. In the embodiment of FIG. 1, the output may be an electric signal representing the combination of selected fields (Q₁A+Q₂C+Q₃B+Q₄D).

In an alternative embodiment, user input can be received through a touch pad or a touch screen that includes embedded touch sensing elements. A user can select an item from the form 120 with his finger, stylus, pencil, or any similar type of object. The contact activates the touch sensing elements embedded in the location of the selected item to generate an output to the handheld reading device 100.

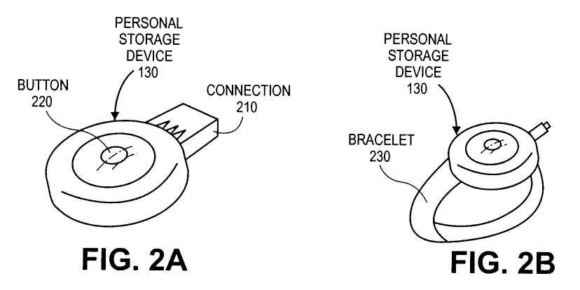

The user's input data is collected by the handheld reading device 100 and stored in the personal storage device 130, an embodiment of which is shown in FIG. 2A. In this embodiment, the personal storage device 130 is shown as having a round shape. However, it is understood that the personal storage device 130 can have any shape. The personal storage device 130 is identified by a unique device ID. The personal storage device 130 includes internal storage to store a user's identification data, such as passwords, personal identifiers (PINs), and biometric data, as well as the device ID and data collected from the form 120 (e.g., data fields selected by a user and the form ID). The personal storage device 130 utilizes a physical connection 210 (e.g., a USB port) or a wireless connection to the handheld reading device 100 for receiving a user's data input. The personal storage device 130 also includes a clickable button 220 for activating and inactivating data storage.

The personal storage device 130 is designed for the dedicated use of an individual. A person can have multiple personal storage devices, each for a different purpose (medical, financial, or other type of data). When not in use, the personal storage device 130 can be carried around by a user as an accessory, such as part of a bracelet 230 (shown in FIG. 2B), a necklace pendant, or other types of wearable or otherwise portable objects. The personal storage device 130 is shown to have a circular shape. One skilled in the art would understand that the principles and features of the described embodiment are applicable to other shapes, form factors and sizes.

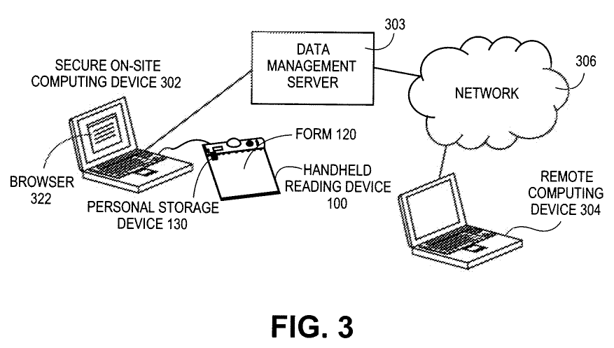

FIG. 3 is a diagram of the network environment in which a system for data management may operate. The network environment includes the handheld reading device 100 (with the attached personal storage device 130) coupled to a secure on-site computer device 302. The network environment also includes a data management server 303 and one or more remote computing devices 304. One of ordinary skill in the art would understand that any number of the handheld reading devices 101, on-site computing devices 302, data management servers 303 and remote computing devices 304 can be used in connection with the system.

In one embodiment, the data management server 303 is coupled to the on-site computing device 302 and the remote computing device 304 over a network 306. The data management server 303 includes an application that collects the data transmitted from the handheld reading device 100 via the on-site computing device 302. The data transmitted includes user data input and the IDs (e.g., a device ID, one or more user identifiers such as name and account number, a form ID, and/or other identifying information). The data may be accessed by another authorized person, such as a physician, a financial consultant, or other authorized personnel, using the remote computing device 304 to obtain information about the user.

The data management server 303 can be connected to any number of the remote computing devices 304 over the network 306. The network 306 can be any type of network including a public network (e.g., Internet), a private network (e.g., Ethernet, a Local Area Network (LAN), or a wide area network (WAN)), or similar networks. The network 306 can include any number of wired or wireless components.

The on-site computing device 302 and the remote computing device 304 can be any type of computer device including a desktop computer, workstation, laptop, console device, wireless device, handheld device, mobile phone or similar computing or multi-functional device capable of executing a general purpose application (e.g., a web browser) that can facilitate contact with the data management server 303 over the network 306. The on-site computing device 302 and the remote computing device 304 can execute any number of applications and can rely on any type of operating system. A general purpose application such as a browser 322 can be utilized by the user or other authorized personnel to access and display the user's account information on a display. The account information is maintained by the data management server 304 and is accessible by the user or other authorized personnel via the network 106.

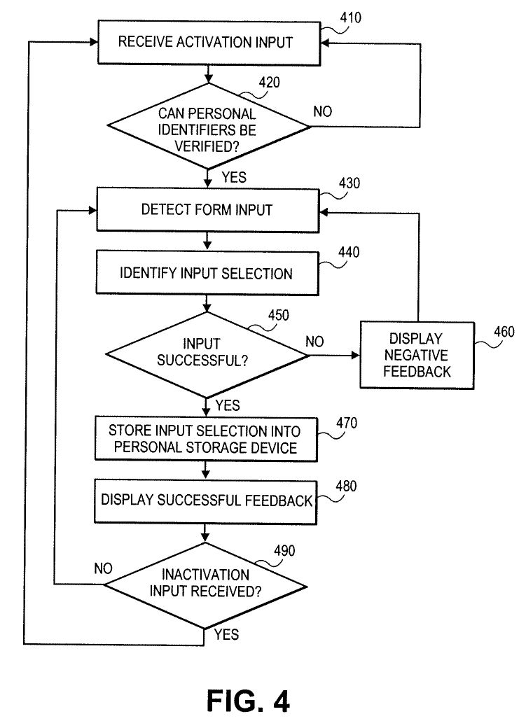

FIG. 4 is a flow diagram showing one embodiment of a process performed by the handheld reading device 100 (FIG. 1) having the personal storage device 130 and a form (such as the form 120) attached thereto. The process starts when a user enters an activation input (block 410). For example, the user can click a button on the personal storage device 130 to activate the recording of data input received from the handheld reading device 100. The user may alternatively or additionally select the reset button 121 on the form 120 to activate data input. After the activation input is received, the handheld reading device 100 receives personal identifiers from the user and verifies the received personal identifiers against the stored identifiers (block 420). The personal identifiers include one or more of a PIN, a password and biometric data, such as a fingerprint. A user can enter his personal identifiers using the access control mechanism 117 on the handheld reading device 100. For example, a user can enter his PIN and password using a keypad, and his fingerprint using an embedded scanner.

If the user's identity cannot be verified (block 420), the process returns to receive the next activation input (block 410). If the identity is verified (block 420), the process proceeds to detect input selection made by the user (block 430), such as the fields or buttons on the form 120 that are selected by the user (block 440). In one embodiment, the form 120 is printed with conductive and/or resistive ink that forms embedded switch circuit elements. The user can select one or more fields, buttons or other selectors on the printed form, with a finger, a graphite pencil, or other objects, to indicate an answer to a question. The selection activates the switch and generates an output. In another embodiment, the handheld reading device 100 may include a touch pad or any touch sensing mechanism for receiving user's selection and to generate an output.

After the user selects an item on the form 120, the handheld reading device 100 determines whether an input selection has been successfully detected (block 450). If the input cannot be detected, the handheld reading device 100 generates negative feedback (block 460); for example, by displaying an error message in a display (e.g., the display 116 of FIG. 1) or announcing an error message with a speaker (e.g., the speaker 118 of FIG. 1). The user can press the clear button 122 on the form 120 to clear the input and re-enter the input on the form 120. The process then returns to block 430 to detect the next input.

If an input selection is successfully detected, the handheld reading device 100 stores the received input selection into the personal storage device 130 (block 470). The handheld reading device 100 then generates successful feedback (block 480), for example, by displaying a successful message in the display 116 or announcing an successful message with the speaker 118. At this point, a user can inactivate the data input process (block 490). If an inactivation input is received, the process returns to block 410 in which the handheld reading device 100 waits for the next activation input. If an inactivation input is not received, the handheld reading device 100 continues to receive a next input selection (block 430). The inactivation input can be received by a user pressing the done button 123 on the form 120 and/or clicking the button 220 (FIG. 2) on the personal storage device 130.

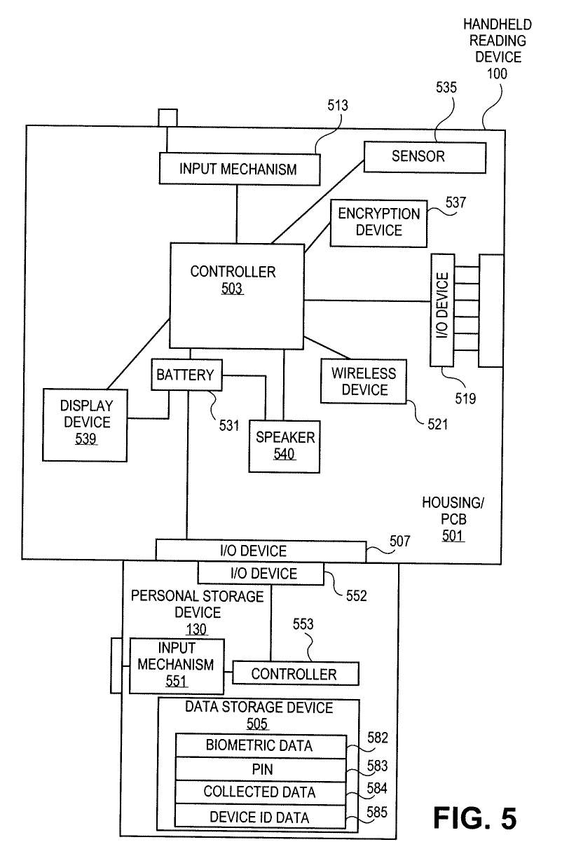

FIG. 5 is a diagram of one embodiment of the handheld reading device 100 with the attached personal storage device 130. In one embodiment, the handheld reading device 100 is composed of a printed circuit board (PCB) 501 within a housing or similar substrate within a similar packaging. In other embodiments, any number of the components of the handheld reading device 100 may be on separate substrates or not attached to substrates. The handheld reading device 100 can have any shape or size. In one embodiment, the handheld reading device 100 has a form factor of clipboard that is roughly rectangular with a size slightly larger than a piece of A4 or letter-sized paper. This form factor is provided by way of example and for the sake of clarity in describing an embodiment of the invention. One skilled in the art would understand that the principles and features of the described embodiment are applicable to other shapes, form factors and sizes.

The handheld reading device 100 includes a controller 503. The controller 503 manages data I/O and the storage of data in personal data storage 130. The controller 503 can be an application specific integrated circuit (ASIC), a general purpose processor or a similar processor or controller. The controller 503 manages the movement of data between the other components of the handheld reading device 100 and also drives the other components of the handheld reading device 100. In one embodiment, the controller 503 incorporates some or all of the other components of the handheld reading device 100. For example, the controller 503 can include an I/O device 519, an encryption device 537, or similar components.

The handheld reading device 100 may also include a battery 531. Any type of battery including an alkaline, lithium, ion, nickel cadmium, nickel metal hydride or similar type of battery can be utilized. The battery 531 provides a power source for the handheld reading device 100. In another embodiment the battery 531 can be replaced or assisted by other power sources such as external power sources, photovoltaic cells or similar power sources. The housing may be configured to allow easy replacement of the battery 531.

The handheld reading device 100 can include any number of communication ports or input devices, such as a first I/O device 507, which can be any type of communication port, protocol or medium. The first I/O device 507 can be a universal serial bus (USB) port, fire wire port, serial port, parallel port or similar communications port. The first I/O device 507 can be connected to any type of physical connector or dongle. The connector can be a male or female connector such as a male or female USB connector. The first I/O device 507 can be used to connect to the personal storage device 130.

A second I/O device 519 can provide the same or an alternative communication medium, connector type or protocol from the first I/O device 507. For example, the second I/O device 519 can be a USB port or a physical connection type dedicated to a specific device such as a handheld device, cellular communication device or similar device. Alternatively, the second I/O device 519 can be a wireless connection mechanism such as RF or infra-red (IR), or any other type of communication port, connector, or communication protocol. The second I/O device 519 can be utilized to transfer and receive data to and from other electronic devices including personal computers, console devices, cellular communication devices and similar electronic devices.

In one embodiment, any of the I/O devices 507 and 519 can be implemented as a wireless device 521. The wireless device 521 can be any type of wireless device including a Bluetooth, 802.11 b/g/n, IR or similar type of wireless communication device.

In one embodiment, the handheld reading device 100 includes an input mechanism 513. The input mechanism 513 can be any type of physical input mechanism connected to the electrical components of the handheld reading device 100 to generate electrical signals to be input into the controller 503 or other components of the handheld reading device 100. The input mechanism 513 can be a set of switches, sliders, buttons, dials, touch pads or similar input mechanisms. These input mechanisms can be used individually or in combination to generate input signals that are processed by the controller 503. The input signals can be processed to select specific data entry in the personal storage device 130.

The handheld reading device 100 can include a sensor 535. The sensor 535 can be any type of detection or sensing device. The sensor 535 can be used to detect any non-digital input such as an electromagnetic, kinetic, energy, light, mechanical or similar force. The sensor 535 can be a resistor, conductive ink, voltmeter, ammeter, ohmmeter, thermometer, photo detector or similar sensor. The sensor 535 can sample or similarly receive the non-digital input to generate an analog value or digital value representing the non-digital input. The sensor 535 can include an analog to digital (A/D) converter, or an analog signal may be passed to the controller 503 or separate analog or digital converter. The controller 503 then converts or receives a digital representation of the non-digital input. This non-digital input can be used to modify existing data or can be stored as new data.

The handheld reading device 100 can include an encryption device 537. The encryption device 537 provides security to the handheld reading device 100 by encrypting and decrypting data transmitted to or from the handheld reading device 100 or within the handheld reading device 100. In another embodiment, the encryption device 537 is a subcomponent of the controller 503. The encryption device 537 also facilitates the management of any protected data managed by the controller 503. The encryption device 537 and the controller 503 can confirm the transfer or deletion of data stored in the personal data storage device 130. This functionality can be utilized to protect the personal data stored in and transferred by the personal storage device 130.

In one embodiment, the handheld reading device 100 can include a display device 539. The display device 539 can be any type of display device including a cathode ray tube (CRT), liquid crystal display (LCD), light emitting diode (LED) or similar display type. The display device 539 can include a graphics controller or the controller 503 can drive the display device 539. The handheld reading device 100 can include any number or size of display devices 539. The display device 539 can provide any resolution and color range including black and white or gray scaled graphics.

In one embodiment, the handheld reading device 100 can include a speaker 540. The speaker 540 can be any type of speaker, such as an electro-acoustic transducer, which converts electrical signals into audible sounds. The speaker 540 receives signals from the controller 503 and converts the signals into sounds to be heard by the user.

In one embodiment, the personal storage device 130 can include any type of persistent storage 505. The persistent storage 505 can be an electronically erasable programmable read only memory (EEPROM) storage device, a static random access memory (SRAM) device or similar persistent storage device. The persistent storage 505 can be any size and hold any amount of data depending on the type and characteristics of the personal storage device 130. In another embodiment, additional storage of any type or size can be included. The additional storage can be used to store different types of data, provide additional space, or facilitate a simpler design. For example, separate storage can be tied to separate input mechanisms 551. Data can be output by the storage when a user selects a corresponding selector of the input mechanism 551.

The personal storage device 130 can store any type of content, links, digital assets, data structures or similar types of data. In one embodiment, the personal storage device 130 stores unique user identifiers such as biometric data 582 and PIN 583. The personal storage device 130 also stores collected data 584 from the form data entry, and a device ID data 585 that uniquely identifies the personal storage device 130. The personal storage device 130 maintains these data entries as part of a standard file system or file directory.

The personal storage device 130 can include a controller 553. The controller 553 manages data I/O and the storage of data in personal data storage 130. The controller 503 can be an application specific integrated circuit (ASIC), a general purpose processor or a similar processor or controller. The controller 553 manages the movement of data between the other components of the personal storage device 130 and also drives the other components of the personal storage device 130.

The personal storage device 130 can also include an I/O device 552, which can be any type of communication port, protocol or medium. The I/O device 552 can be a universal serial bus (USB) port, fire wire port, serial port, parallel port or similar communications port. The I/O device 552 can be connected to any type of physical connector or dongle, such as a corresponding I/O port (e.g., the I/O device 507) of the handheld reading device 100. The connector can be a male or female connector such as a male or female USB connector.

In one embodiment, the form management system including the handheld reading device 100, the personal storage device 130 and their components are implemented as hardware systems and devices. In another embodiment, some of the components in the brand experience system are implemented as software (e.g., microcode, assembly language or higher level languages) stored on a computer-readable medium. A “computer-readable” medium may include a computer readable storage medium and any medium that can store or transfer information. Examples of a computer-readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method, comprising:
collecting data through a handheld form reading device; and
storing the data on a personal storage device removably coupled to the handheld form reading device.

2. The method of claim 1, further comprising:
restricting data access on the personal storage device based on biometric user data.

3. The method of claim 1, further comprising:
detecting data signals from a writing utensil or touchpad.

4. The method of claim 1, further comprising:
identifying a field corresponding to the data collected from the handheld form reading device.

5. The method of claim 1, further comprising:
displaying feedback in response to user input.

6. The method of claim 1, further comprising:
displaying data through the handheld form reading device that is stored on the personal storage device.

7. The method of claim 1, further comprising:
inactivating data collection in response to a user activation of the personal storage device.

8. The method of claim 1, further comprising:
transmitting the data to an external computing device.

9. A system comprising:
a housing having a handheld form factor;
an input mechanism coupled to the housing, the input mechanism to receive user data input through a touchpad or writing utensil;
a biometric control mechanism coupled to the housing to measure user biometric data;
a personal storage device removably coupled to the housing to receive and store data from the input mechanism in response to verification of user biometric data from the biometric control mechanism based on user biometric data stored on the personal storage device.

10. The system of claim 9, further comprising:
a display device coupled to the input mechanism to display storage and input feedback to a user.

11. The system of claim 9, wherein the personal storage device comprises:
an activation medium to activate and deactivate data access.

12. A computer-readable storage medium, having instructions stored therein, which when executed cause a computer to perform a set of operations comprising:
collecting data through a handheld form reading device; and
storing the data on a personal storage device removably coupled to the handheld form reading device.

13. The computer-readable storage medium of claim 12, having further instructions stored therein, which when executed cause a computer to perform a set of operations further comprising:
restricting data access on the personal storage device based on biometric user data.

14. The computer-readable storage medium of claim 12, having further instructions stored therein, which when executed cause a computer to perform a set of operations further comprising:
detecting data signals from a writing utensil or touchpad.

15. The computer-readable storage medium of claim 12, having further instructions stored therein, which when executed cause a computer to perform a set of operations further comprising:
identifying a field corresponding to the data collected from the handheld form reading device.

16. The computer-readable storage medium of claim 12, having further instructions stored therein, which when executed cause a computer to perform a set of operations further comprising:
displaying feedback in response to user input.

17. The computer-readable storage medium of claim 12, having further instructions stored therein, which when executed cause a computer to perform a set of operations further comprising:
displaying data through the handheld form reading device that is stored on the personal storage device.

18. The computer-readable storage medium of claim 12, having further instructions stored therein, which when executed cause a computer to perform a set of operations further comprising:
inactivating data collection in response to a user activation of the personal storage device.

19. The computer-readable storage medium of claim 12, having further instructions stored therein, which when executed cause a computer to perform a set of operations further comprising:
transmitting the data to an external computing device.
